(19) United States
(12) Patent Application Publication
(10) Pub. No.: US 2019/0203533 A1
(43) Pub. Date: Jul. 4, 2019

(54) INFLATABLE LADDERS AND USES THEREOF

(71) Applicant: Frank Thomas, Cumming, GA (US)

(72) Inventor: Frank Thomas, Cumming, GA (US)

(21) Appl. No.: 16/234,122

(22) Filed: Dec. 27, 2018

Related U.S. Application Data
(60) Provisional application No. 62/611,628, filed on Dec. 29, 2017.

(51) Int. Cl. E06C 1/52; E06C 7/00; E06C 7/08

(52) U.S. Cl. CPC E06C 1/52; E06C 7/08; E06C 7/003

(57) ABSTRACT

Disclosed are fully inflatable ladders and partially inflatable ladders having a first inflatable side rail and second inflatable side rail and support elements. Disclosed are fully inflatable ladders comprising inflatable rungs and partially inflatable ladders comprising non-inflatable rungs. Also disclosed are methods of forming the disclosed ladders.

### CROSS-REFERENCE TO RELATED APPLICATIONS

This application claims benefit of U.S. Provisional Application No. 62/611,628, filed Dec. 29, 2017, which is hereby incorporated herein by reference in its entirety.

### BACKGROUND

Ladders on the rooftop of a vehicle can lead to increased fuel consumption. However, carrying ladders inside of a vehicle is hindered by storage capacity within each vehicle. Thus, disclosed herein are inflatable ladders that can be stored within most vehicles and helps reduce fuel consumption.

### BRIEF SUMMARY

Disclosed are ladders comprising a first inflatable side rail comprising an inner side and an outer side and defining an interior space for receiving air, wherein the inner side comprises a plurality of openings distributed along a length of the inner side; a second inflatable side rail comprising an inner side and an outer side and defining an interior space for receiving air, wherein the inner side comprises a plurality of openings distributed along a length of the inner side, wherein in the fully inflated condition, the first inflatable side rail and second inflatable side rail are substantially parallel and each opening of the inner side of the first inflatable side rail is positioned in alignment with a corresponding opening of the inner side of the second inflatable side rail to define a plurality of pairs of opposing openings; a plurality of inflatable rungs, wherein each of the plurality of inflatable rungs defines an interior space and is secured to the inner surfaces of the first inflatable side rail and second inflatable side rail such that the interior space of the inflatable rung is in airtight fluid communication with the interior spaces of the first inflatable side rail and second inflatable side rail through a respective pair of opposing openings, wherein the plurality of inflatable rungs form a single contiguous chamber with the first inflatable side rail and second inflatable side rail, a plurality of support elements positioned within the interior spaces of the plurality of inflatable rungs, wherein at least one support element is positioned within the interior space of each inflatable rung, and wherein each support element contacts an interior surface of a respective inflatable rung in at least two circumferentially spaced locations such that the support element spans across at least a portion of the interior space of the inflatable rung; and a first sealable opening in the first inflatable side rail through which air is receivable to permit selective inflation or deflation of the first inflatable side rail, the second inflatable side rail, and the plurality of rungs.

Also disclosed are ladders comprising a first inflatable side rail comprising an inner side 104 and an outer side and defining an interior space for receiving air; a second inflatable side rail comprising an inner side and an outer side and defining an interior space for receiving air; a plurality of non-inflatable rungs, wherein each of the plurality of non-inflatable rungs comprises a first end and second end, wherein the first end contacts the first inflatable side rail and the second end contacts the second inflatable side rail; a first sealable opening in the first inflatable side rail through which air is receivable to permit selective inflation or deflation of the first inflatable side rail; and a second sealable opening in the second inflatable side rail through which air is receivable to permit selective inflation or deflation of the second inflatable side rail.

Disclosed are methods of forming a usable ladder comprising attaching an air compressor to the first sealable opening of any one of the disclosed fully inflatable ladders; filling the fully inflatable ladder with air; and removing the air compressor and sealing the first sealable opening.

Disclosed are methods of forming a usable ladder comprising attaching an air compressor to the first sealable opening of any one of the disclosed partially inflatable ladders; filling the first inflatable side rail with air; removing the air compressor and sealing the first sealable opening; attaching an air compressor to the second sealable opening of the partially inflatable ladder; filling the second inflatable side rail with air; and removing the air compressor and sealing the second sealable opening.

Additional advantages of the disclosed method and compositions will be set forth in part in the description which follows, and in part will be understood from the description, or may be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIG. 1 shows a drawing of an example of an inflatable ladder in a fully inflated ladder

FIG. 2 shows a drawing of an example of an inflatable ladder in an uninflated position rolled up.

FIG. 3 shows a drawing of an example of an inflatable ladder in a partial inflated position.

FIG. 4 shows a drawing of an example of a cross section of an inflated ladder showing support elements.

FIG. 5 shows a drawing of an inflated ladder attached to an air compressor.

FIG. 6 shows a drawing of an example of a partially inflatable ladder in a fully inflated position.

### DETAILED DESCRIPTION

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a,” “an,” and “the” include plural reference unless the context clearly dictates otherwise. Thus, for example, reference to “a support element” includes a plurality of such support elements, reference to “the inflatable rung” is a reference to one or more inflatable rungs and equivalents thereof known to those skilled in the art, and so forth.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

The phrase “substantially parallel” refers to the first inflatable side rail and the second inflatable side rail being parallel for at least 10, 20, 30, 40, 50, 60, 70, 80, 90, or 100% of their longitudinal axis or longitudinal length.

The phrase “substantially perpendicular” refers to the inflatable rungs or non-inflatable rungs being perpendicular to the first inflatable side rail and/or second inflatable side rail wherein at least one of the angles, where the rung meets the side rail, is a 20, 30, 40, 50, 60, 70, 80, or 90 degree angle.

“Dimensionally fixed” refers to the measurements being a set amount with only minimal fluctuation. For example, a fully inflatable ladder comprising sufficient air pressure provides a dimensionally fixed structure wherein the length, width, and thickness of the fully inflatable ladder remain constant with minimal fluctuation. Minimal fluctuation refers to the measurements of the length, width and thickness of the fully inflatable ladder being within 1, 2, 3, 4, 5, 6, 7, 8, 9, 10, 15, 20, or 25% of the set amount.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Disclosed is a ladder wherein at least some or all portions of the ladder are inflatable (e.g. fully inflatable ladder or partially inflatable. The ladder can be used on land or in water. For example, the ladder can be used to reach a rooftop or can be used to climb in and out of a boat.

A fully inflatable ladder is a ladder wherein a first side rail, a second side rail, and the plurality of rungs of the ladder can be inflated. A partially inflatable ladder is a ladder comprising at least a plurality of non-inflatable rungs wherein other elements, such as the side rails, can be inflatable.

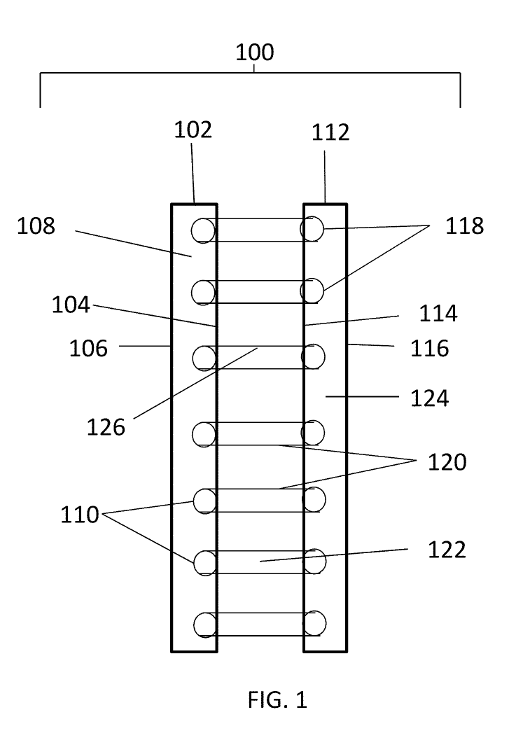

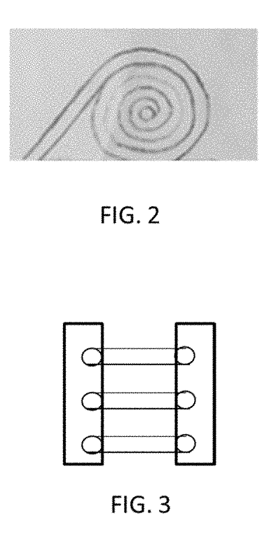

In an aspect, shown in FIG. 1, a fully inflatable ladder 100 is disclosed comprising a first inflatable side rail 102. The first inflatable side rail 102 can comprise an inner side 104 and an outer side 106. The inner side 104 and the outer side 106 define an interior space 108 for receiving air (or other gas). The inner side 104 can comprises a plurality of openings 110 distributed along a length of the inner side 104.

The fully inflatable ladder 100 can comprise a second inflatable side rail 112. The second inflatable side rail 112 can comprise an inner side 114 and an outer side 116. The inner side 114 and the outer side 116 define an interior space 124 for receiving air (or other gas). The inner side 114 can comprise a plurality of openings 118 distributed along a length of the inner side 114. In a fully inflated condition, the first inflatable side rail 102 and second inflatable side rail 112 can be substantially parallel. When the first inflatable side rail 102 and second inflatable side rail 112, are substantially parallel, each opening of the inner side 104 of the first inflatable side rail 102 is positioned in alignment with a corresponding opening of the inner side 114 of the second inflatable side rail 112. The alignment of the plurality of openings 110 distributed along a length of the inner side 104 of the first inflatable side rail 102 and the plurality of openings 118 distributed along a length of the inner side 114 of the second inflatable side rail 112 define a plurality of pairs of opposing openings. For example, each opening distributed along a length of the inner side 104 of the first inflatable side rail 102 has an opposing opening on the inner side 114 of the second inflatable side rail 112. When the fully inflatable ladder 100 is in the fully inflated position, the plurality of pairs of opposing openings can be directly across from each other thus making the plurality of inflatable rungs substantially perpendicular to the first inflatable side rail 102 and second inflatable side rail 112.

The fully inflatable ladder 100 can comprise a plurality of inflatable rungs 120. Each of the plurality of inflatable rungs 120 defines an interior space 122. Each of the plurality of inflatable rungs 120 can be secured to the inner sides 104 and 124 of the first inflatable side rail 102 and second inflatable side rail 112, respectively, such that the interior space 122 of the inflatable rung is in airtight fluid communication with the interior space 108 of the first inflatable side rail 102 and interior space 124 of the second inflatable side rail 112 through a respective pair of opposing openings. The plurality of inflatable rungs 120 forms a single contiguous chamber with the first inflatable side rail 102 and second inflatable side rail 112. In some aspects, in the fully inflated condition, the plurality of inflatable rungs 120 are substantially perpendicular to the first inflatable side rail 102 and second inflatable side rail 112.

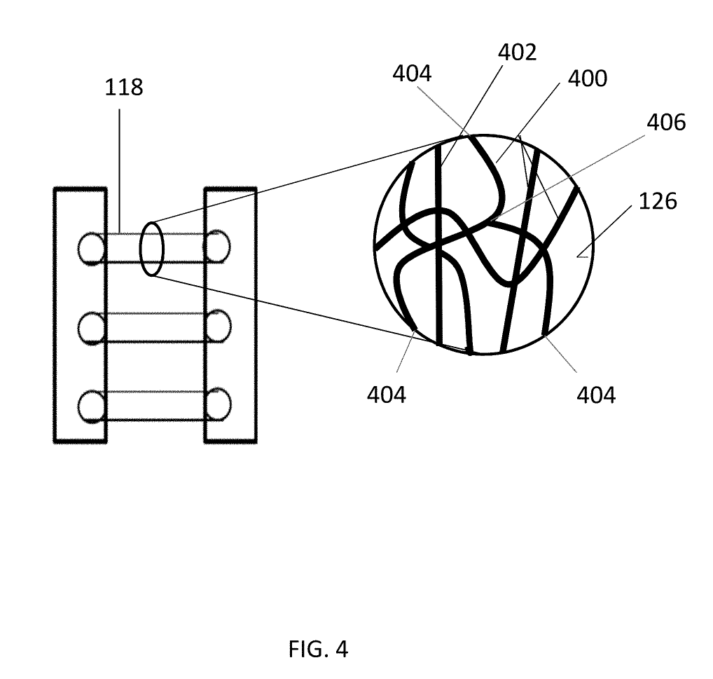

In an aspect, one or more of the plurality of inflatable rungs 120 of the fully inflatable ladder 100 can comprise a plurality of support elements 400, as show in FIG. 4. A plurality of support elements 400 can be one support element that branches and thus contacts one inflatable rung of the plurality of inflatable rungs 120 in at least three circumferentially spaced locations 404 or can be two or more support elements. The plurality of support elements 400 can be positioned within the interior space 122 of the plurality of inflatable rungs 120. Each support element of the plurality of support elements 400 can contact an interior surface 126 of a respective inflatable rung 120 in at least two circumferentially spaced locations. Thus, each support element of the plurality of support elements 400 can span across at least a portion of the interior space 122 of at least one of the plurality of inflatable rungs 120. In some aspects, the plurality of support elements 400 can be inflatable. In some aspects, support elements 400 can be deployed from a collapsed and/or reduced air pressure configuration into an extended and/or deployed configuration, upon inflation of the support elements 400. In some aspects, the plurality of support elements 400 each comprise an interior chamber 402. In some aspects, support elements 400 can be inflated via delivery of pressurized gas (e.g., air) in the interior chamber 402. For example, in some aspects, the interior chamber 402 of each of the plurality of support elements 400 can be filled with air. In some aspects, the interior chamber 402 runs the length of each of the plurality of support elements 400. In some aspects, a size of an interior chamber 402 can be proportional to a size of the support element 400. In some aspects, a support element 400 can comprise more than one interior chamber 402. In some aspects, an interior chamber 402 can have one or more open ends. In some aspects, an interior chamber 402 can have one open end and one sealed end. In some aspects, at least one of the plurality of support elements 400 contacts the interior surface 126 of at least one of the plurality of rungs 120 in at least three circumferentially spaced locations 404. In some aspects, at least one of the plurality of support elements 400 contacts the interior surface 126 of at least one of the plurality of inflatable rungs 120 in at least two circumferentially spaced locations that are offset relative to a length of the inflatable rung 120. In some aspects, the support elements 400 are not limited to a particular shape. In some aspects, the support elements 400 can be any shape suitable for supporting an external mass, such as but not limited to, elongate or globular. For example, the support elements 400 can be, but are not limited to, an elongate shape such as a beam, a cylinder, a tube, a rod, a shaft, a joist, a stud, combinations thereof, or any other shapes suitable for a support element 400. In some aspects, a support element 400 can comprise one or more elongate portions and one or more globular portions. In some aspects, globular portions can be spherical, ovular, polygonal, box-shaped, combinations thereof, or any other shapes suitable for a support element 400. In some aspects, an elongate support element has any suitable cross-sectional shape (e.g., circular, polygonal (e.g., square, rectangular, hexagonal, etc.), I-shape, ovular, teardrop, etc.). In some aspects, a support element 400 can comprise an elongate tubular structure. In some aspects, at least one of the plurality of support elements 400 can be tapered over the length of the support element. In some aspects, one of the plurality of support elements 400 can comprise one or more attachment points 406 for interaction with additional support elements 400, structural elements, and/or functional elements. In some aspects, the plurality of support elements 400 can be present in the first inflatable side rail 102 and second inflatable side rail 112

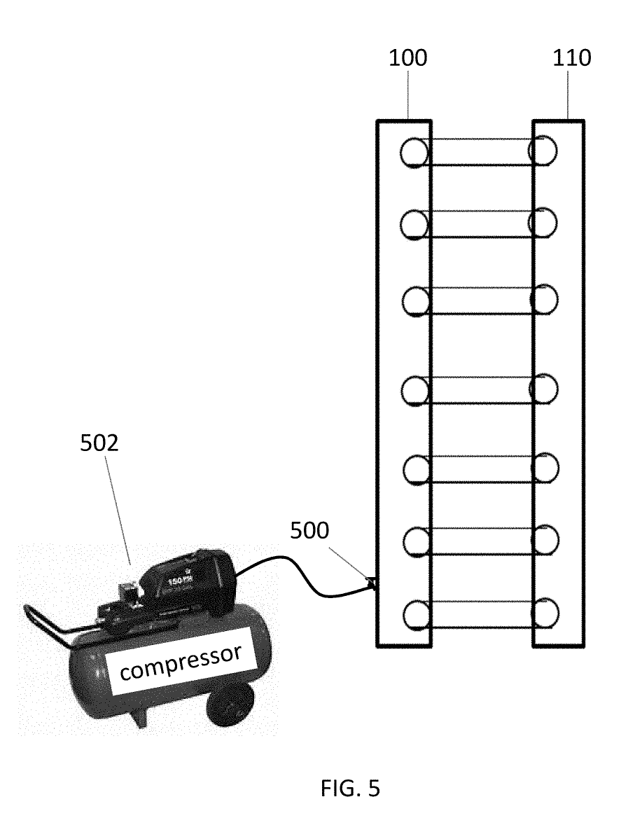

In some aspects, the fully inflatable ladder 100 can comprise a first sealable opening 500. The first sealable opening 500 in the first inflatable side rail 102 through which air is receivable to permit selective inflation or deflation of the first inflatable side rail 102, the second inflatable side rail 112, and/or the plurality of rungs 120. In some aspects, as shown in FIG. 5, the first sealable opening 500 can be attached to an air compressor 502. In some aspects, the first sealable opening 500 can comprise a valve. Thus, the air compressor 502 can fit into the first sealable opening 500 via the valve. In some aspects, the air compressor 502 can comprise an adaptor to fit the valve within the first sealable opening 500.

In some aspects, the fully inflatable ladder 100 can further comprise a second sealable opening for attaching a pneumatic tool. In some aspects, the pneumatic tool can be, but is not limited to, a nail gun, a drill, a hammer, a saw, a stapler, a screwdriver, an air accessory, a riveter, an impact wrench, a grinder, a paint sprayer, and the like. In some aspects, the second sealable opening can be located in the first inflatable side rail 102. In some aspects, the second sealable opening can be located in the second inflatable side rail 112.

In some aspects, the fully inflatable ladder 100 can further comprise a gauge for measuring an amount of internal air pressure. The gauge can be present anywhere on the ladder. For example, in some aspects, the gauge can be located near the first sealable opening. In some aspects, the ladder 100 can further comprise an internal air pressure of 102 to 325 psi.

In some aspects, the fully inflatable ladder 100 can be composed of a vinyl material. In some aspects, the fully inflatable ladder can be composed of, but is not limited to, a high tensile woven fabric or rubber. In some aspects, the vinyl material can be polyvinyl chloride or vinyl and nylon. In some aspects, the fully inflatable ladder 100 can be composed of a material such that when the internal chamber 402 of the plurality of support elements 400 are filled with compressed air to an adequate pressure the form is rigid and dimensionally fixed. In some aspects, the plurality of support elements 400 can be made of a different material than the first inflatable side rail 102, second inflatable side rail 112, or plurality of inflatable rungs 120.

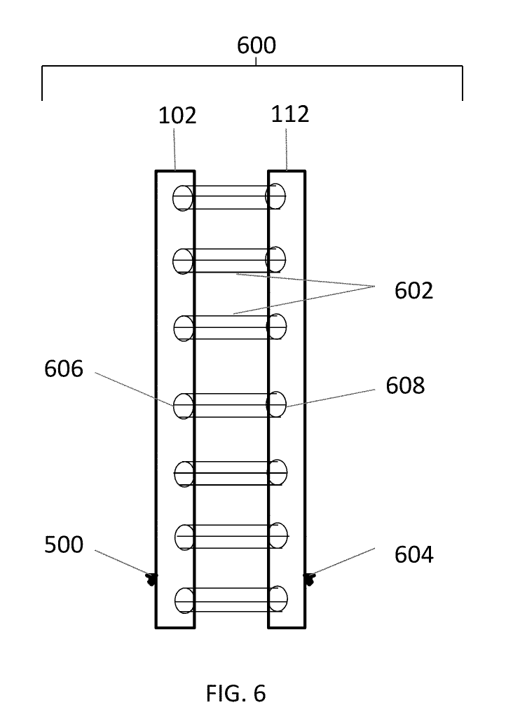

In some aspects, the ladder can be a partially inflatable ladder 600. In some aspects, the partially inflatable ladder 600 comprises a first inflatable side rail 102 and a second inflatable side rail 112 as described for the fully inflatable ladder. As shown in FIG. 6, a partially inflatable ladder 600 can comprise a first inflatable side rail 102 and a second inflatable side rail 112 similar to the disclosed fully inflatable ladder 100, however, the partially inflatable ladder 600 comprises a plurality of non-inflatable rungs 602. The plurality of non-inflatable rungs 602 each can comprise a first end 606 and second end 608. The first end 606 can contact the first inflatable side rail 102 and the second end 608 can contact the second inflatable side rail 102. In some aspects, the plurality of non-inflatable rungs 602 can be composed of metal, plastic, rope, fabric, wood, aluminum, ultra high molecular weight dimensionally stable polymer, or any combination thereof. In some aspects, the non-inflatable rungs 602 are substantially perpendicular to the first inflatable side rail 102 and second inflatable side rail 112 when the ladder is fully inflated.

The partially inflatable ladder 600 can comprise a first sealable opening 500 in the first inflatable side rail 102 through which air is receivable to permit selective inflation or deflation of the first inflatable side rail 102. In some aspects, the first inflatable side rail 102 and the second inflatable side rail 112 can be connected in a manner that allows air to pass between the first inflatable side rail 102 and the second inflatable side rail 112. Thus, the partially inflatable ladder can be inflated using the first sealable opening 500. In some aspects, a partially inflatable ladder 600 can comprise a second sealable opening 604 in the second inflatable side rail 112 through which air is receivable to permit selective inflation or deflation of the second inflatable side rail 112. Having a first sealable opening 500 and a second sealable opening 604 allows for the inflation of the first inflatable side rail 102 and second inflatable side rail 112 separately. In some aspects, the first sealable opening 500 and the second sealable opening 604 can comprise a valve. In some aspects, the air compressor 502 fits into the first sealable opening 500 and the second sealable opening 604 via the valve. In some aspects, the air compressor 502 can comprise an adaptor to fit the valve within the first sealable opening 500 and second sealable opening 604.

The partially inflatable ladder 600 can comprise a plurality of support elements 400 in the first inflatable side rail 102 and second inflatable side rail 112 as described for the fully inflatable ladder 100.

In some aspects, a partially inflatable ladder 600 can further comprise a third sealable opening for attaching a pneumatic tool. In some aspects, a pneumatic tool can be, but is not limited to, a nail gun, a drill, a hammer, a saw, a stapler, a screwdriver, an air accessory, a riveter, an impact wrench, a grinder, a paint sprayer, and the like. In some aspects, a third sealable opening can be located in the in the first inflatable side rail 102, just like the first sealable opening 500. In some aspects, a third sealable opening can be located in the second inflatable side rail 112 just like the second sealable opening 604.

In some aspects, a partially inflatable ladder 600 can comprise a gauge, have the same air pressure and/or can be attached to an air compressor 502 as described for a fully inflatable ladder 100.

Disclosed are methods of forming a usable ladder comprising attaching an air compressor 502 to the first sealable opening 500 of any one of the disclosed fully inflatable ladders 100; filling the fully inflatable ladder 100 with air; and removing the air compressor 502 and sealing the first sealable opening 500.

In some aspects of the disclosed methods, filling the inflatable ladder with air comprises ending inflation once the air pressure reaches 102-325 psi.

Disclosed are methods of forming a usable ladder comprising attaching an air compressor 502 to the first sealable opening 500 of any one of the disclosed partially inflatable ladders 600; filling the first inflatable side rail 102 with air; removing the air compressor 502 and sealing the first sealable opening 500; attaching an air compressor 502 to the second sealable opening 604 of the partially inflatable ladder 600; filling the second inflatable side rail 112 with air; and removing the air compressor 502 and sealing the second sealable opening 604.

In some aspects of the disclosed methods, wherein filling the inflatable ladder with air comprises stopping the filling once the air pressure reaches 102 to 325 psi. In some aspects, stopping the filling once the air pressure reaches 102 to 325 psi can occur by watching the gauge present on the ladder.

Disclosed is an apparatus comprising a housing unit configured to receive any one of the disclosed ladders (fully inflatable or partially inflatable ladders) in a deflated state.

In some aspects of the disclosed apparatus, the apparatus can be configured to fit in a vehicle.

Those skilled in the art will recognize, or be able to ascertain using no more than routine experimentation, many equivalents to the specific embodiments of the method and compositions described herein. Such equivalents are intended to be encompassed by the following claims.

We claim:

1. A fully inflatable ladder comprising:
a first inflatable side rail comprising an inner side and an outer side and defining an interior space for receiving air, wherein the inner side comprises a plurality of openings distributed along a length of the inner side;
a second inflatable side rail comprising an inner side and an outer side and defining an interior space for receiving air, wherein the inner side comprises a plurality of openings distributed along a length of the inner side, wherein in the fully inflated condition, the first inflatable side rail and second inflatable side rail are substantially parallel and each opening of the inner side of the first inflatable side rail is positioned in alignment with a corresponding opening of the inner side of the second inflatable side rail to define a plurality of pairs of opposing openings;
a plurality of inflatable rungs, wherein each of the plurality of inflatable rungs defines an interior space and is secured to the inner surfaces of the first inflatable side rail and second inflatable side rail such that the interior space of the inflatable rung is in airtight fluid communication with the interior spaces of the first inflatable side rail and second inflatable side rail through a respective pair of opposing openings, wherein the plurality of inflatable rungs form a single contiguous chamber with the first inflatable side rail and second inflatable side rail,
a plurality of support elements positioned within the interior spaces of the plurality of inflatable rungs, wherein at least one support element is positioned within the interior space of each inflatable rung, and wherein each support element contacts an interior surface of a respective inflatable rung in at least two circumferentially spaced locations such that the support element spans across at least a portion of the interior space of the inflatable rung; and
a first sealable opening in the first inflatable side rail through which air is receivable to permit selective inflation or deflation of the first inflatable side rail, the second inflatable side rail, and the plurality of rungs.

2. The fully inflatable ladder of claim 1, further comprising a second sealable opening for attaching a pneumatic tool.

3. The fully inflatable ladder of claim 2, wherein the pneumatic tool is a nail gun, drill, hammer, saw, stapler, screwdriver, air accessory, riveters, impact wrench, grinder, or paint sprayer.

4. The fully inflatable ladder of any one of claims 1-3, further comprising a gauge for measuring the amount of internal air pressure.

5. The fully inflatable ladder of any one of claims 1-4, wherein the first sealable opening is attached to an air compressor.

6. The fully inflatable ladder of any one of claims 1-5, wherein the inflatable ladder is composed of a vinyl material.

7. The fully inflatable ladder of claim 6, wherein the vinyl material is polyvinyl chloride or vinyl and nylon.

8. The fully inflatable ladder of any one of claims 1-7, further comprising an internal air pressure of 102 to 325 psi.

9. The fully inflatable ladder of any one of claims 1-8, wherein in the fully inflated condition, the plurality of inflatable rungs are substantially perpendicular to the first inflatable side rail and second inflatable side rail.

10. The fully inflatable ladder of any one of claims 1-9, wherein the plurality of support elements are inflatable.

11. The fully inflatable ladder of any one of claims 1-10, wherein the plurality of support elements each comprise an interior space.

12. The fully inflatable ladder of claim 11, wherein the interior space of each of the plurality of support elements is filled with air.

13. The fully inflatable ladder of any one of claims 1-12, wherein the plurality of support elements are present in the first inflatable side rail and second inflatable side rail.

14. The fully inflatable ladder of claim 1-13, wherein at least one of the plurality of support elements contacts the interior surface of a respective inflatable rung in at least three circumferentially spaced locations.

15. The fully inflatable ladder of claim 1-13, wherein at least one of the plurality of support elements contacts the interior surface of a respective inflatable rung in at least two circumferentially spaced locations that are offset relative to a length of the inflatable rung.

16. A partially inflatable ladder comprising:
a first inflatable side rail comprising an inner side and an outer side and defining an interior space for receiving air;
a second inflatable side rail comprising an inner side and an outer side and defining an interior space for receiving air;
a plurality of non-inflatable rungs, wherein each of the plurality of non-inflatable rungs comprises a first end and second end, wherein the first end contacts the first inflatable side rail and the second end contacts the second inflatable side rail;
a first sealable opening in the first inflatable side rail through which air is receivable to permit selective inflation or deflation of the first inflatable side rail; and
a second sealable opening in the second inflatable side rail through which air is receivable to permit selective inflation or deflation of the second inflatable side rail.

17. The partially inflatable ladder of claim 16, wherein the one or more non-inflatable rungs are composed of metal, plastic, rope, fabric, wood, or any combination thereof

18. The partially inflatable ladder of any one of claims 16-17, further comprising a plurality of support elements positioned within the interior spaces of the first inflatable side rail and second inflatable side rail, wherein at least one support element is positioned within the interior space of each inflatable side rail, and wherein each support element contacts an interior surface of a respective inflatable side rail in at least two circumferentially spaced locations such that the support element spans across at least a portion of the interior space of one of the first inflatable side rail or second inflatable side rail.

19. The partially inflatable ladder of any one of claims 16-18, further comprising a third sealable opening for attaching a pneumatic tool.

20. The partially inflatable ladder of claim 19, wherein the pneumatic tool is a nail gun, drill, hammer, saw, stapler, screwdriver, air accessory, riveters, impact wrench, grinder, or paint sprayer.

21. The partially inflatable ladder of any one of claims 16-20, further comprising a gauge for measuring the amount of internal air pressure.

22. The partially inflatable ladder of any one of claims 16-21, wherein the first sealable opening or the second sealable opening is attached to an air compressor.

23. The partially inflatable ladder of any one of claims 16-22, wherein the first inflatable side rail and second inflatable side rail are composed of a vinyl material.

24. The partially inflatable ladder of claim 23, wherein the vinyl material is polyvinyl chloride or vinyl and nylon.

25. The partially inflatable ladder of any one of claims 16-24, wherein the first inflatable side rail and second inflatable side rail comprise an internal air pressure of 102 to 325 psi.

26. The partially inflatable ladder of any one of claims 16-25, wherein in the fully inflated condition, the non-inflatable rungs are substantially perpendicular to the first inflatable side rail and second inflatable side rail.

27. The partially inflatable ladder of any one of claims 18-26, wherein the support elements each comprise an interior space.

28. The partially inflatable ladder of any one of claims 18-27, wherein the plurality of support elements is inflatable.

29. The partially inflatable ladder of claim 27, wherein the interior space of at least one of the plurality of support elements is filled with air.

30. The partially inflatable ladder of any one of claims 18-29, wherein the plurality of support elements is present in the first inflatable side rail and second inflatable side rail.

31. The partially inflatable ladder of claim 18, wherein at least one support element contacts the interior surface of the first inflatable side rail or second inflatable side rail in at least three circumferentially spaced locations.

32. The partially inflatable ladder of claim 18-31, wherein at least one support element contacts the interior surface of the first inflatable side rail or second inflatable side rail in at least two circumferentially spaced locations that are offset relative to a length of the first inflatable side rail or second inflatable side rail.

33. A method of forming a usable ladder comprising
i. attaching an air compressor to the first sealable opening of the fully inflatable ladder of any one of claims 1-15;
ii. filling the fully inflatable ladder with air; and
iii. removing the air compressor and sealing the first sealable opening.

34. The method of claim 33, wherein filling the fully inflatable ladder with air comprises ending inflation once the air pressure reaches 102-325 psi.

35. A method of forming a usable ladder comprising i. attaching an air compressor to the first sealable opening of the partially inflatable ladder of any one of claims 16-32;
ii. filling the first inflatable side rail with air;
iii. removing the air compressor and sealing the first sealable opening;
iv. attaching an air compressor to the second sealable opening of the partially inflatable ladder of any one of claims 16-32;
v. filling the second inflatable side rail with air; and
vi. removing the air compressor and sealing the second sealable opening.

36. The method of claim 35, wherein filling the partially inflatable ladder with air comprises ending inflation once the air pressure reaches 102 to 325 psi.

37. An apparatus comprising
i. a housing unit configured to receive the inflatable ladder of any one of claims 1-32 in a deflated state; and
ii. the inflatable ladder of any one of claims 1-32.

38. The apparatus of claim 37, wherein the apparatus is configured to fit in a vehicle.
